(19) United States
(12) Patent Application Publication
(10) Pub. No.: US 2025/0044743 A1
(43) Pub. Date: Feb. 6, 2025

(54) OPERATION METHOD OF ELECTRONIC APPARATUS, ELECTRONIC APPARATUS AND STORAGE MEDIUM

(71) Applicant: SAMSUNG ELECTRONICS CO., LTD., Suwon-si (KR)

(72) Inventors: Suxian ZHANG, Guangzhou (CN); Huihui YANG, Guangzhou (CN); Zhongwei ZHANG, Guangzhou (CN); Kechi XIE, Guangzhou (CN)

(73) Assignee: SAMSUNG ELECTRONICS CO., LTD., Suwon-si (KR)

(21) Appl. No.: 18/922,096

(22) Filed: Oct. 21, 2024

Related U.S. Application Data
(63) Continuation of application No. PCT/KR2023/004608, filed on Apr. 5, 2023.

(30) Foreign Application Priority Data
Aug. 11, 2022 (CN) 202210962509.9

(51) Int. Cl. G04G 13/02; G01S 5/02

(52) U.S. Cl. CPC G04G 13/021; G01S 5/0284; G04G 13/025

(57) ABSTRACT

Provided is a method of operating an electronic apparatus, an electronic apparatus, and a storage medium. The method of operating a first electronic apparatus includes: acquiring alarm clock setting information of at least one alarm clock from at least one second electronic apparatus; determining, based on the alarm clock setting information, an alarm sound playing direction corresponding to each alarm clock of the at least one alarm clock; and for each alarm clock of the at least one alarm clock, playing an alarm sound corresponding to the alarm clock toward the alarm sound playing direction corresponding to the alarm clock.

### CROSS-REFERENCE TO RELATED APPLICATIONS

This application is a by-pass continuation of International Application No. PCT/KR2023/004608, filed on Apr. 5, 2023, which is based on and claims priority to Chinese Patent Application No. 202210962509.9, filed in the Chinese National Intellectual Property Administration on Aug. 11, 2022, the disclosures of which are incorporated by reference herein in their entireties.

### BACKGROUND

### 1. Field

The present disclosure relates to the field of the Internet of Things (IoT), and particularly, to an operation method of an electronic apparatus, the electronic apparatus and a storage medium.

### 2. Description of Related Art

At present, with the continuous development of IoT technology, the concept of the internet of everything has gradually penetrated into people's hearts. Different devices can communicate with each other, making it possible for some traditional household appliances or devices to be redefined. Almost everyone has the experience of setting an alarm clock. Take a wake-up alarm clock as an example. In a co-living environment, it often happens that the alarm clock set by oneself affects others, or oneself is affected by the alarm clock set by others. Since the alarm clock is usually set for a single person, and the same alarm clock is very noisy to other people in sleep, there is a need for a technology that can provide alarm clock service without affecting others.

### SUMMARY

Provided is an electronic apparatus designed to address impact of an alarm clock on other individuals in the vicinity of the alarm clock, a method of operating said apparatus, and a storage medium related thereto.

According to an aspect of the disclosure, a method of operating a first electronic apparatus includes: acquiring alarm clock setting information of at least one alarm clock from at least one second electronic apparatus; determining, based on the alarm clock setting information, an alarm sound playing direction corresponding to each alarm clock of the at least one alarm clock; and for each alarm clock of the at least one alarm clock, playing an alarm sound corresponding to the alarm clock toward the alarm sound playing direction corresponding to the alarm clock.

The alarm clock setting information may include alarm time information for each alarm clock of the at least one alarm clock, alarm sound information for each alarm clock of the at least one alarm clock, and related information of a third electronic apparatus matched with each alarm clock of the at least one alarm clock.

The third electronic apparatus may be the at least one second electronic apparatus.

The determining the alarm sound playing direction corresponding to each alarm clock of the at least one alarm clock may include: determining a position of the third electronic apparatus based on the related information of the third electronic apparatus matched with each alarm clock of the at least one alarm clock; and determining the alarm sound playing direction of each alarm clock of the at least one alarm clock according to the determined position of the third electronic apparatus.

The determining the position of the third electronic apparatus based on the related information of the third electronic apparatus may include determining the position of the third electronic apparatus using ultra wideband (UWB) positioning technology.

The determining, based on the alarm clock setting information, the alarm sound playing direction corresponding to each alarm clock of the at least one alarm clock may include: determining an alarm sound playing time of each alarm clock of the at least one alarm clock according to the alarm clock setting information; and determining, for each alarm clock of the at least one alarm clock, within a predetermined time before the alarm sound playing time, the alarm sound playing direction corresponding to the alarm clock.

The at least one alarm clock may include a plurality of alarm clocks, the first electronic apparatus may include a plurality of sound players, and for each alarm clock of the plurality of alarm clocks, the playing the alarm sound corresponding to the alarm clock toward the alarm sound playing direction corresponding to the alarm clock may further include: based on the alarm sound playing time of each alarm clock of the plurality of alarm clocks being the same, simultaneously playing, through the plurality of sound players, the alarm sound corresponding to each alarm clock toward the respective alarm sound playing direction corresponding to each of the plurality of alarm clocks.

The at least one alarm clock may include a plurality of alarm clocks, the first electronic apparatus may include one sound player, and for each alarm clock of the plurality of alarm clocks, the playing of the alarm sound corresponding to each alarm clock toward the respective alarm sound playing direction may include: based on the alarm sound playing time of each of the plurality of alarm clocks being the same, alternately playing in time intervals, through the one sound player, the alarm sound corresponding to each alarm clock in the respective alarm sound playing direction corresponding to each respective alarm clock of the plurality of alarm clocks.

The acquiring the alarm clock setting information of the at least one alarm clock from the at least one second electronic apparatus may include: receiving the alarm clock setting information directly from the at least one second electronic apparatus; or acquiring the alarm clock setting information via an intermediate communication apparatus or by accessing a cloud device.

According to an aspect of the disclosure, a method of operating an alarm management system includes: generating, by at least one second electronic apparatus, alarm clock setting information of at least one alarm clock; sending, by the at least one second electronic apparatus, the alarm clock setting information to a first electronic apparatus; determining, by the first electronic apparatus, an alarm sound playing direction corresponding to each alarm clock of the at least one alarm clock based on the alarm clock setting information; and playing, by the first electronic apparatus for each alarm clock of the at least one alarm clock, an alarm sound corresponding to the alarm clock toward the alarm sound playing direction.

The alarm clock setting information may include alarm time information for each alarm clock of the at least one alarm clock, alarm sound information for each alarm clock of the at least one alarm clock, and related information of a third electronic apparatus matched with each alarm clock of the at least one alarm clock.

The third electronic apparatus may be the at least one second electronic apparatus, the first electronic apparatus and the third electronic apparatus may each include an ultra-wideband (UWB) module, the method may further include: establishing a communication connection between the first electronic apparatus and the at least one second electronic apparatus; exchanging a UWB ranging parameter between the first electronic apparatus and the at least one second electronic apparatus, and the determining, by the first electronic apparatus, the alarm sound playing direction corresponding to each alarm clock of the at least one alarm clock may further include determining the alarm sound playing direction corresponding to each alarm clock of the at least one alarm clock using the UWB ranging parameter.

The generating the alarm clock setting information of the at least one alarm clock may include: outputting, by the at least one second electronic apparatus, prompt information to a user; based on expectation information provided by the user in response to the prompt information, identify whether the user expects the alarm sound corresponding to each alarm clock of the at least one alarm clock to be output by the first electronic apparatus; based on identifying that the user expects the alarm sound corresponding to each alarm clock of the at least one alarm clock to be output by the first electronic apparatus, outputting a user interface for setting a third electronic apparatus matched with each of the at least one alarm clock; and based on an input received through the user interface, generating related information of the third electronic apparatus matched with each of the at least one alarm clock as at least part of the alarm clock setting information.

The sending the alarm clock setting information to the first electronic apparatus may include: sending the alarm clock setting information directly to the first electronic apparatus; or sending the alarm clock setting information to the first electronic apparatus via an intermediate communication apparatus or a cloud device.

According to an aspect of the disclosure, a first electronic apparatus includes: at least one memory storing one or more instructions; and at least one processor configured to execute the one or more instructions, wherein the one or more instructions, when executed by the at least one processor, cause the first electronic apparatus to: acquire alarm clock setting information of at least one alarm clock from at least one second electronic apparatus, determine, based on the alarm clock setting information, an alarm sound playing direction corresponding to each alarm clock of the at least one alarm clock, and for each alarm clock of the at least one alarm clock, play an alarm sound corresponding to the alarm clock toward the alarm sound playing direction corresponding to the alarm clock.

The alarm clock setting information may include alarm time information for each alarm clock of the at least one alarm clock, alarm sound information for each alarm clock of the at least one alarm clock, and related information of a third electronic apparatus matched with each alarm clock of the at least one alarm clock.

The one or more instructions, when executed by the at least one processor, may cause the first electronic apparatus to: determine a position of the third electronic apparatus based on the related information of the third electronic apparatus matched with each alarm clock of the at least one alarm clock, and determine the alarm sound playing direction of each alarm clock of the at least one alarm clock according to the determined position of the third electronic apparatus.

The one or more instructions, when executed by the at least one processor, may cause the first electronic apparatus to: determine the position of the third electronic apparatus using ultra wideband positioning technology.

The one or more instructions, when executed by the at least one processor, may cause the first electronic apparatus to: determine an alarm sound playing time of each alarm clock of the at least one alarm clock according to the alarm clock setting information; and determine, for each alarm clock of the at least one alarm clock, within a predetermined time before the alarm sound playing time, the alarm sound playing direction corresponding to the alarm clock.

According to an aspect of the disclosure, a non-transitory computer readable medium having instructions stored therein, which when executed by at least one processor cause the at least one processor to execute a method of operating a first electronic apparatus including: acquiring alarm clock setting information of at least one alarm clock from at least one second electronic apparatus; determining, based on the alarm clock setting information, an alarm sound playing direction corresponding to each alarm clock of the at least one alarm clock; and for each alarm clock of the at least one alarm clock, playing an alarm sound corresponding to the alarm clock toward the alarm sound playing direction corresponding to the alarm clock.

It should be understood that the above general description and the following detailed description are only exemplary and explanatory, and do not limit the present disclosure.

### BRIEF DESCRIPTION OF THE DRAWINGS

The drawings herein are incorporated into the specification and form a part of the specification, showing exemplary embodiments consistent with the disclosure, and are used together with the specification to explain the principles of the disclosure, and do not constitute an improper limitation of the disclosure. The above and other aspects and features of certain embodiments of the present disclosure will be more apparent from the following description taken in conjunction with the accompanying drawings, in which:

FIG. 1 is a diagram showing an alarm ring scene in a common living environment;

FIG. 2 is a flowchart of an operation method of the first electronic apparatus according to one or more embodiments of the present disclosure;

FIG. 3 shows a schematic diagram of a network connection scheme including a first electronic apparatus and a second electronic apparatus according to one or more embodiments of the present disclosure;

FIG. 4 shows a schematic diagram of bilateral bidirectional ranging according to one or more embodiments of the present disclosure;

FIG. 5 shows a schematic diagram of three antennas positioning a third electronic apparatus according to one or more embodiments of the present disclosure;

FIG. 6 is a schematic diagram of directional playback of an alarm clock sound according to one or more embodiments of the present disclosure;

FIG. 7 is a schematic diagram showing a scheme in which a plurality of sound players play a plurality of alarm clock sounds according to one or more embodiments of the present disclosure;

FIG. 8 is a schematic diagram showing a scheme in which a sound player plays a plurality of alarm clock sounds according to one or more embodiments of the present disclosure;

FIG. 9 is a flowchart of an operation method of a second electronic apparatus according to an exemplary embodiment of the present disclosure according to one or more embodiments of the present disclosure;

FIG. 10 is a schematic diagram showing setting of a third electronic apparatus matched with an alarm clock according to one or more embodiments of the present disclosure;

FIG. 11 is a block diagram of a first electronic apparatus according to an exemplary embodiment of the present disclosure according to one or more embodiments of the present disclosure;

FIG. 12 is a block diagram of a second electronic apparatus according to one or more embodiments of the present disclosure; and

FIG. 13 is a block diagram of an electronic apparatus according to one or more embodiments of the present disclosure.

### DETAILED DESCRIPTION

In order to make those skilled in the art better understand the present disclosure, one or more embodiments of the present disclosure will be described below in conjunction with the drawings.

It needs to be noted that terms “first”, “second” and the like in the description and claims and the above-described drawings of the present disclosure are used to distinguish similar objects, and not necessarily used to describe a specific order or precedence order. It should be understood that the number thus used may be exchanged if appropriate, so that the embodiments of the present disclosure described herein can be implemented in an order other than those illustrated or described herein. The implementations described in the following embodiments do not represent all embodiments consistent with the present disclosure. On the contrary, they are merely examples of devices and methods consistent with some aspects of the present disclosure, as detailed in the appended claims.

It needs to be noted herein that “at least one of several items” appearing in the present disclosure refers to three types of parallel cases including “any one of the several items”, “combination of any of the several items” and “all of the several items”. For example, “including at least one of A and/or B” includes the following three parallel cases: (1) including A; (2) including B; (3) including A and B. For another example, “performing at least one of step 1 and step 2” refers to the following three parallel cases: (1) performing step 1; (2) performing step 2; (3) performing step 1 and step 2.

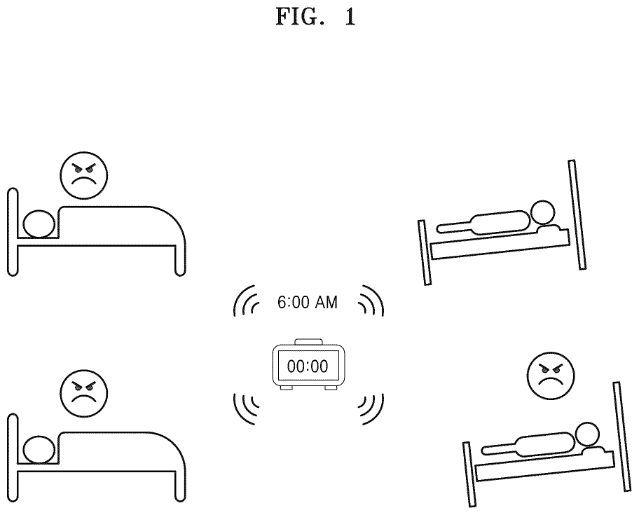

As described in the background of the present application, it often happens that the alarm clock set by oneself affects others or oneself is affected by the alarm clock set by others in a co-living environment. FIG. 1 is a diagram illustrating an alarm clock ringing scene in a co-living environment. For example, in the school dormitory, because Xiaohua had to take an exam on Saturday morning, she set the alarm activate at 6 o'clock the next day. At 6 o'clock the next day, every one heard Xiaohua's mobile phone alarm when sleeping, which directly affects the quality of sleeping of everyone in the vicinity of the alarm. Therefore, the present disclosure provides a method and apparatus capable of making the sound of the alarm clock not affect others. The method and apparatus provided in the present disclosure may effectively prevent the played alarm clock sound from affecting others by playing the alarm clock sound corresponding to each alarm clock toward the alarm clock sound playing direction corresponding to each alarm clock.

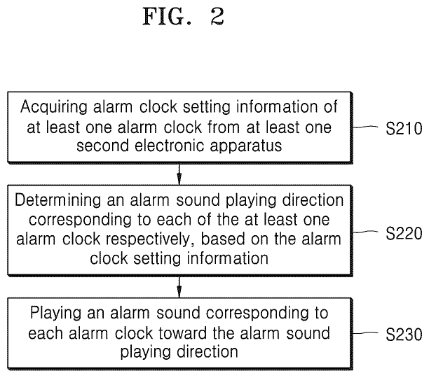

FIG. 2 is a flowchart of an operation method of a first electronic apparatus according to one or more embodiments of the present disclosure.

At operation S210, alarm clock setting information of at least one alarm clock from at least one second electronic apparatus is acquired. In the present application, the first electronic apparatus may be an apparatus that plays an alarm sound, for example, an intelligent alarm clock. The second electronic apparatus may be an apparatus by which the user sets the alarm clock, for example, a mobile phone, a wearable apparatus, etc. As an example, at operation S210, the alarm clock setting information may be directly received from the at least one second electronic apparatus. Or, the alarm clock setting information may be acquired via an intermediate communication apparatus or accessing a cloud. A mode in which the first electronic apparatus acquires the alarm clock setting information may depend on a communication mode between the first electronic apparatus and the second electronic apparatus.

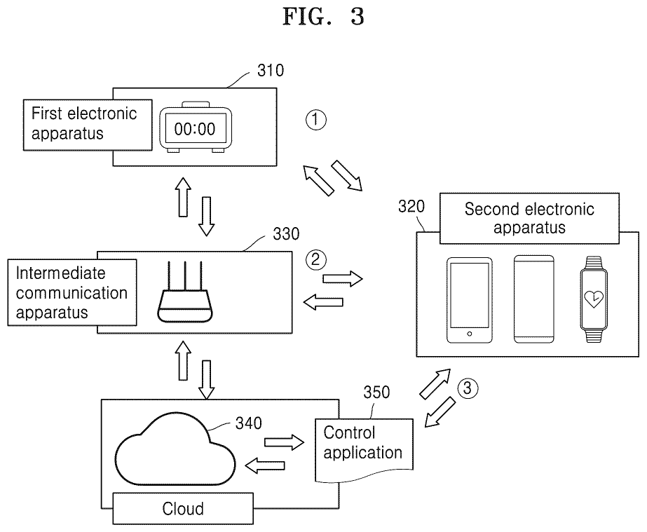

Specifically, FIG. 3 illustrates a schematic diagram of a network connection scheme including the first electronic apparatus (310) and the second electronic apparatus (320).

In FIG. 3, three network connection schemes are illustrated. As illustrated in FIG. 3, a first network connection mode \textcircled{1} is provided wherein the first electronic apparatus (310) and the at least one second electronic apparatus (320) are connected through a short distance connection mode such as Wi-Fi direct connection or BT, etc., and in this case, at operation S210, the first electronic apparatus (310) may receive the alarm clock setting information from the at least one second electronic apparatus (320) through the short distance connection mode such as Wi-Fi direct connection or BT, etc., directly.

A second network connection mode \textcircled{2} is provided wherein the first electronic apparatus (310) and the second electronic apparatus (320) are under the same access point, and in this case, at operation S210, the first electronic apparatus (310) may acquire the alarm clock setting information via an intermediate communication apparatus (330) (e.g., a router).

A third network connection mode \textcircled{3} is provided wherein both the first electronic apparatus (310) and the second electronic apparatus (320) are connected to a cloud (340) through a data network (e.g., a cellular network) or a Wi-Fi network. In this case, the second electronic apparatus (320) may send the alarm clock setting information to the cloud (340) for storing, through a control application (350), and then at operation S210, the first electronic apparatus (310) may acquire the alarm clock setting information by accessing the cloud (340).

According to an embodiment, the alarm clock setting information described above may include alarm time information, alarm sound information of each of the at least one alarm clock, and related information of a third electronic apparatus matched with each alarm clock, but not limited thereto. For example, the alarm clock setting information described above may also include alarm name information, etc. The alarm time information may include alarm playing start time, alarm playing duration, alarm playing interval, etc. The alarm sound information includes a name, loudness, a playing mode of the alarm sound (vibration or alarm music), etc. The related information of the third electronic apparatus matched with each alarm clock may include name of the third electronic apparatus and physical address (MAC address) of the third electronic apparatus, etc. Here, the third electronic apparatus may be the same as or different from the second electronic apparatus (320). As described above, the second electronic apparatus (320) may be an electronic apparatus for setting the alarm clock, the third electronic apparatus may be the second electronic apparatus (320) itself, or the third electronic apparatus may be another electronic apparatus, which may be the apparatus that the user usually keeps close to him or wears with him, for example, a mobile phone that is placed beside the user when sleeping, or a wearable device (e.g., a smart watch, a smart bracelet, etc.) that is worn when sleeping. Thus position and direction information of the user with respect to the first electronic apparatus (310) may be determined by positioning the third electronic apparatus. The alarm clock service may be provided only to the user corresponding to the third electronic apparatus by playing the alarm sound only toward the third electronic apparatus, to avoid affecting others. According to an embodiment, the third electronic apparatus matched with each alarm clock may be one electronic apparatus or a plurality of electronic apparatus.

In the co-living environment, if there are multiple second electronic apparatuses (320), each of the second electronic apparatuses (320) may set the alarm clock, and then synchronize the set alarm clock information to the first electronic apparatus (310). In addition, one second electronic apparatus (320) may set at least one alarm clock. Therefore, at operation S210, the first electronic apparatus (310) may acquire the alarm clock setting information of the at least one alarm clock from the at least one second electronic apparatus (320). For example, Table 1 below illustrates an example of alarm clock setting information acquired by the first electronic apparatus (310).

TABLE 1

| | | | Name of the | Mac address |
|---|---|---|---|---|
| Alarm | Alarm | Alarm | third electronic | of the third |
| name | time | sound | apparatus | electronic apparatus |
| Alarm 1 | AM 6:00 | Horizon | Uncle Suger's | MacAddress1 = |
| | | | S21; | 1a48ca4198999899 |
| | | | Uncle Suger's | MacAddress 2 = |
| | | | Galaxy Watch | 1a48ca4199976553 |
| Alarm 2 | AM 6:15 | Horizon | Lindar's S20 | Mac Address = |
| | | | | 1a48ca4168598962 |
| Alarm 3 | AM 6:15 | Horizon | Lucy's S20 | MacAddress = |
| | | | | 1a48ca5899048889 |
| Alarm 4 | AM 7:00 | Horizon | My son's S20 | MacAddress = |
| | | | | 1a48ca7639748883 |
| Alarm 5 | AM 6:00 | Horizon | My father's S20 | MacAddress = |
| | | | | 1a48ca4875544281 |

As shown in the above table, the alarm time of the alarm clock named “Alarm 1” is “AM 6:00”, its corresponding alarm sound is the ringtone “Horizon”, and the third electronic apparatus matched with the alarm clock is two electronic apparatus, the names of these two electronic apparatus are “Uncle Suger's S21” (the electronic apparatus may be a mobile phone, for example) and “Uncle Suger's Galaxy Watch” (the electronic apparatus may be a smart watch, for example) respectively, their MAC addresses are MacAddress1=1a48ca4198999899 and MacAddress 2=1a48ca4199976553, respectively. The alarm time of the alarm clock named “Alarm 2” is “AM 6:00”, its corresponding alarm sound is the ringtone “Horizon”, the third electronic apparatus matched with the alarm clock is one electronic apparatus, its name and MAC address are “Lindar's S20” and “MacAddress=1a48ca4168598962”, respectively. Accordingly, the third electronic apparatus matched to each alarm clock may be one electronic apparatus or a plurality of electronic apparatus. The alarm clocks “Alarm 1” to “Alarm 5” described above may be alarm clocks from the same second electronic apparatus (320), or may be alarm clocks from different second electronic apparatus (320). For example, different students in the same dormitory may set their own alarm clocks through their own second electronic apparatus (320), respectively, and then send the set alarm clock setting information to the first electronic apparatus (310), whereby the first electronic apparatus (310) may obtain the alarm clock setting information of the plurality of alarm clocks from the plurality of second electronic apparatus (320). Or, one student in the dormitory may, by his second electronic apparatus (320), set the alarm clock(s) only for himself, or for other students in addition to for himself, and at this time, the first electronic apparatus (310) may acquire the alarm clock setting information of the at least one alarm clock from one second electronic apparatus (320). In addition, the first electronic apparatus (310) may store the acquired alarm clock setting information.

After acquiring the alarm clock setting information, next, at operation S220, the alarm sound playing direction corresponding to each of the at least one alarm clock is determined based on the alarm clock setting information. For example, an alarm sound playing time of each alarm clock may be determined according to the alarm clock setting information, and the alarm sound playing direction corresponding to each of the at least one alarm clock respectively is determined based on the alarm clock setting information, within a predetermined time before the alarm sound playing time. As described above, the alarm clock setting information may include the alarm time information, and the alarm sound playing time of each alarm clock (that is, when the alarm sound is played) may be determined according to the alarm time information. In addition, in order to successfully play the alarm sound in an appropriate direction at the alarm sound playing time, the alarm sound playing direction corresponding to each of the at least one alarm clock may be determined based on the alarm clock setting information, within a predetermined time before the alarm sound playing time. For example, the alarm sound playing direction corresponding to each alarm clock may be determined 5 minutes before each alarm clock is predetermined to ringing, and then, when the alarm time arrives, the alarm sound playing direction corresponding to each alarm clock may be determined based on the alarm clock setting information.

How to determine the alarm sound playing direction corresponding to each of the at least one alarm clock based on the alarm clock setting information will be described below.

Specifically, for example, the determining of the alarm sound playing direction corresponding to each of the at least one alarm clock respectively, based on the alarm clock setting information, may include: at first, a position of the third electronic apparatus may be determined based on the related information of the third electronic apparatus matched with each alarm clock, and then the alarm sound playing direction of each alarm clock may be determined according to the determined position of the third electronic apparatus. According to an embodiment, the position of the third electronic apparatus may be determined by using ultra wideband (UWB) positioning technology, based on the related information of the third electronic apparatus matched with each alarm clock. For example, as described above, the related information may include the physical address of the third electronic apparatus, and in this case, a distance between the first electronic apparatus (310) and the third electronic apparatus may be measured according to the physical address of the third electronic apparatus, and the position of the third electronic apparatus may be determined based on the measured distance.

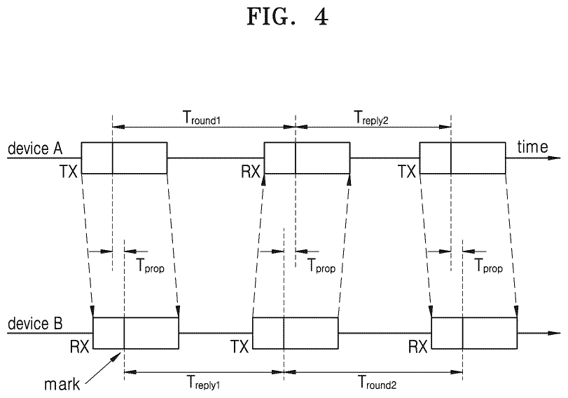

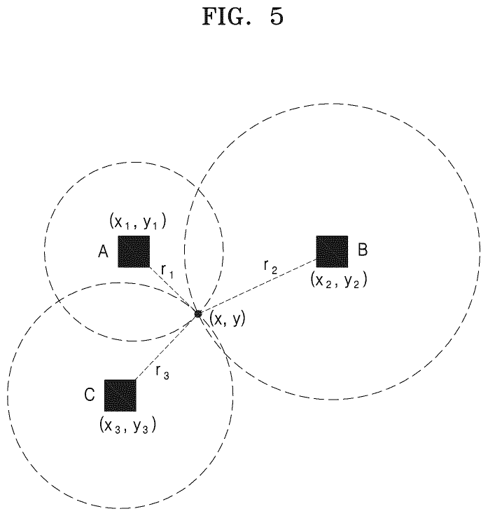

An exemplary manner of determining the position of the third electronic apparatus to determine the alarm sound playing direction based on the position is described below with reference to FIGS. 4 and 5 in conjunction with examples.

According to embodiments of the present disclosure, the first electronic apparatus (310) and the third electronic apparatus may include an ultra-wideband (UWB) module. With UWB technology, it is easy to integrate positioning and communication, which is difficult for conventional radio. The UWB technology has extremely strong penetration ability, and may perform precise positioning indoors and underground, while global positioning system (GPS) may only work within a visual range of GPS positioning satellites. Different from an absolute geographical position being provided by GPS, the ultra-wideband radio locator may give a relative position, and its positioning accuracy may reach centimeter level. In addition, the ultra-wideband radio locator is cheaper in price.

In the case that the related information of the third electronic apparatus included in the alarm clock setting information includes the physical address of the third electronic apparatus, the first electronic apparatus (310) may first establish a communication connection with the third electronic apparatus according to the physical address of the third electronic apparatus, and exchange ultra-wideband (UWB) ranging parameters with the third electronic apparatus. Then, based on the exchanged UWB ranging parameters, the distance between the first electronic apparatus (310) and the third electronic apparatus is measured by using Double Sided Two-Way Ranging DS-TWR mode.

For example, the first electronic apparatus (310) (e.g., the smart alarm clock) may establish a Bluetooth Low Energy (BLE) connection with the third electronic apparatus (e.g., the smart watch) according to the physical address of the third electronic apparatus, and exchange ultra-wideband (UWB) ranging parameters with the third electronic apparatus through the BLE GATT (Generic Attribute Profile). For example, Bluetooth Low Energy (BLE) connections are mostly now built on the top of the GATT protocol. The GATT is a general specification for sending and receiving short data segments over Bluetooth connections. These short data segments may be called attributes. According to the embodiment of the present disclosure, the ultra-wideband (UWB) ranging parameters may be predefined parameters, which may include a ranging mode (e.g., Double Sided Two-Way Ranging (DS-TWR)), a session ID (a continuous ranging process between apparatus is called a ranging session, and the session ID of each ranging session is unique), MAC address of the first electronic apparatus (310)/MAC address of the third electronic apparatus, Scramble Timestamp Sequence (STS), search mode (for example, the first electronic apparatus (310) searches only one third electronic apparatus at a time), device roles of the first electronic apparatus (310) and the third electronic apparatus (for example, the first electronic apparatus (310) is the controller and the third electronic apparatus is the controlled when the communication exchange), but not limited thereto. IEEE 802.15.4z, the latest specification of UWB, adds one important function in the physical layer, namely Scramble Timestamp Sequence (STS). STS uses encryption and random number generation technology in the meantime to protect timestamp data. Because the timestamp data is used to determine the precise distance between two objects to each other, so any tampering with or manipulating the timestamp means that you can make the distance seems more or less. STS makes it extremely difficult for the rival to intercept and change the important timestamp data sent by the UWB apparatus.

In the following, assuming that the received UWB ranging parameters indicate that the ranging mode is Double Sided Two-Way Ranging, the first electronic apparatus (310) may measure the distance between the first electronic apparatus (310) and the third electronic apparatus by using the Double Sided Two-Way Ranging mode.

FIG. 4 illustrates a schematic diagram of Double Sided Two-Way Ranging. As illustrated in FIG. 4, a device A (the UWB module of the first electronic apparatus (310)) and a device B (the UWB module of the third electronic apparatus) are two UWB modules, the ranging is initiated by the device A first, and the device B sends back a response after receiving the ranging, the device A, after receiving the response, initiates a transmission to the device B again, thus completing a ranging. Each time device A and device B send data and receive data, they should mark the current time stamp. Time T_{round1} of the device A from the initiation of ranging to the receipt of the response of the device B and time T_{reply2} of the device A from the receipt of the response of the device B to the re-initiation of ranging, and time T_{reply2} of the device B from the receipt of the response of the device A to the initiation of ranging and time T_{round2} of the device B from the initiation of ranging to the receipt of the response of the device A, may be determined respectively according to the recorded time stamp. Based on the above determined time, flight time \hat{T}ₚᵣₒₚ may be calculated by the following equation.

$${\hat{T}}_{prop} = \frac{( {T}_{round 1} \times {T}_{round 2} − {T}_{reply 1} \times {T}_{reply 2} )}{( {T}_{round 1} + {T}_{round 2} + {T}_{reply 1} + {T}_{reply 2} )} \qquad Equation 1$$

After the flight time is determined, the distance between the first electronic apparatus (310) and the third electronic apparatus may be determined by multiplying the flight time by light speed c.

According to an embodiment, after the distance between the first electronic apparatus (310) and the third electronic apparatus is measured, the position of the third electronic apparatus may be determined based on the measured distance. As an example, the first electronic apparatus (310) may include a plurality of antennas. The distance between the first electronic apparatus (310) and the third electronic apparatus may be a distance between each antenna of the first electronic apparatus (310) and the third electronic apparatus, measured by using the above ranging mode.

FIG. 5 illustrates a schematic diagram of three antennas positioning the third electronic apparatus. As illustrated in FIG. 5, assuming that the distances from three antennas (antenna A, antenna B, and antenna C) of the first electronic apparatus to a fourth electronic apparatus are r1, r2, and r3 respectively, measured by DS-TWR, the position coordinate (x, y) of the third electronic apparatus with respect to the first electronic apparatus may be obtained based on the distances r1, r2, and r3 and the coordinates (x1, y1), (x2, y2) and (x3, y3) of the antenna A, antenna B, and antenna C. Based on the coordinate, an azimuth angle α of the third electronic apparatus with respect to the first electronic apparatus may be determined, wherein α=arctan (y/x). The direction corresponding to the azimuth angle may be the alarm sound playing direction corresponding to the alarm clock.

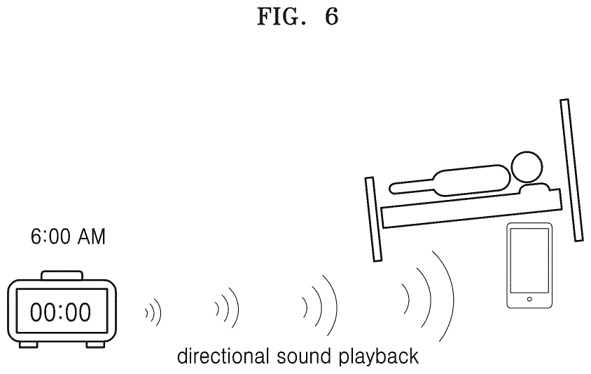

Referring back to FIG. 2, after determining the alarm sound playing direction corresponding to each of the at least one alarm clock, at operation S230, the alarm sound corresponding to each alarm clock may be played in the alarm sound playing direction. FIG. 6 is a schematic diagram of directional playing of the alarm sound. For example, as illustrated in FIG. 6, the directional sound playback technology may be used to play the corresponding alarm sound in the alarm sound playing direction corresponding to each alarm clock.

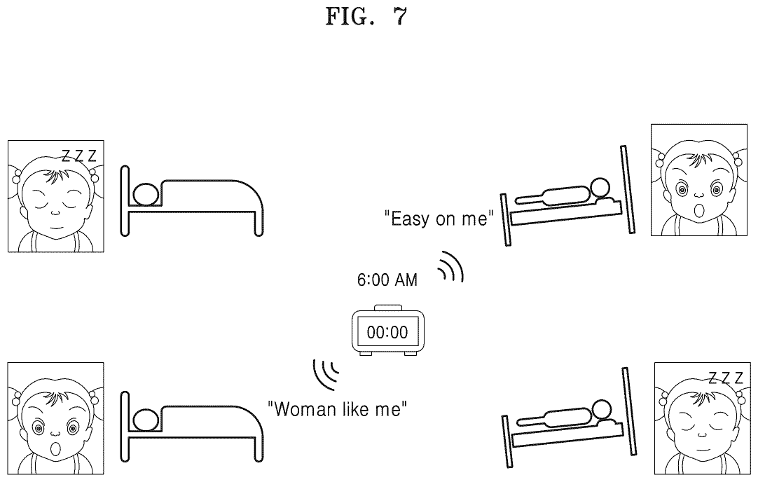

According to an exemplary embodiment, the at least one alarm clock may be a plurality of alarm clocks, and the first electronic apparatus may include a plurality of sound players, and in this case, the playing of the alarm sound corresponding to each alarm clock toward the alarm sound playing direction, may include: if it is determined that alarm times of the plurality of alarm clocks are the same according to the setting information, the alarm sound corresponding to each alarm clock is played in the alarm sound playing direction corresponding to each of the plurality of alarm clocks, by using the plurality of sound players simultaneously at the alarm times. That is, each sound player is responsible for playing the corresponding alarm sound in one alarm sound playing direction. For example, in an actual scene, there may be two or more alarm clocks to play on the smart alarm clock at the same time, and the played alarm sounds are different, in this case, if the smart alarm clock includes a plurality of speakers, each speaker may play one alarm sound in one direction. FIG. 7 is a schematic diagram illustrating a scheme in which a plurality of sound players play a plurality of alarm sounds. As illustrated in FIG. 7, if the smart alarm clock needs to play the alarm clocks of two users at 6:00 AM, and the smart alarm clock has the plurality of speakers, one speaker may play the alarm “Easy on me” of the user 1 in the determined direction 1 corresponding to the alarm clock set by the user 1, another speaker may play the alarm “Woman like me” of the user 2 in the direction 2 corresponding to the alarm clock set by the user 2, while other users in the same space may not be disturbed.

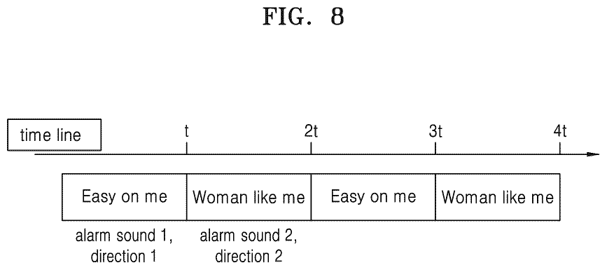

Alternatively, the at least one alarm clock is a plurality of alarm clocks, and the first electronic apparatus may include one sound player, and in this case, the playing of the alarm sound corresponding to each alarm clock toward the alarm sound playing direction, may include: if it is determined that alarm times of the plurality of alarm clocks are the same according to the setting information, the alarm sound corresponding to each alarm clock is played alternately toward the alarm sound playing direction corresponding to each of the plurality of alarm clocks in time intervals starting from the alarm times by using the one sound player. That is, users in different directions can receive different alarm sounds, by using the mode of playing in intervals. FIG. 8 is a schematic diagram illustrating a scheme in which one sound player plays a plurality of alarm sounds. As illustrated in FIG. 8, if the smart alarm clock needs to play the alarm clocks of two users at 6:00 AM, and the smart alarm clock has only one speaker, the alarm “Easy on me” of the user 1 may be played in the determined direction 1 corresponding to the alarm clock set by the user 1 within a period from 0 to t by using the one speaker, the alarm “Woman like me” of the user 2 is played in the determined direction 2 corresponding to the alarm clock set by the user 2 within a period from t to 2t, the alarm “Easy on me” of the user 1 is played in the direction 1 within a period from 2t to 3t, the alarm “Woman like me” of the user 2 is played in the direction 2 within a period from 3t to 4t, and it is continuously played alternately, until a predetermined time to stop playing.

In the above, the operation method of the first electronic apparatus according to the embodiment of the present disclosure has been described with reference to FIGS. 1 to 8. Since the alarm sound playing direction corresponding to each of the at least one alarm clock respectively is determined based on the alarm clock setting information after acquiring the alarm clock setting information of the at least one alarm clock, and then, the alarm sound corresponding to each alarm clock is played toward the alarm sound playing direction, instead of the alarm sound being played in the whole space, the alarm clock service can be provided directionally, thereby reducing the impact of the alarm sound on others.

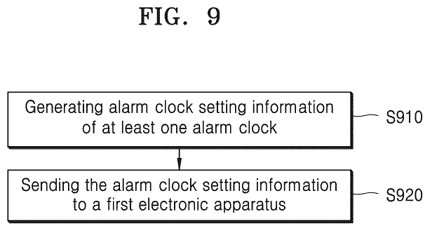

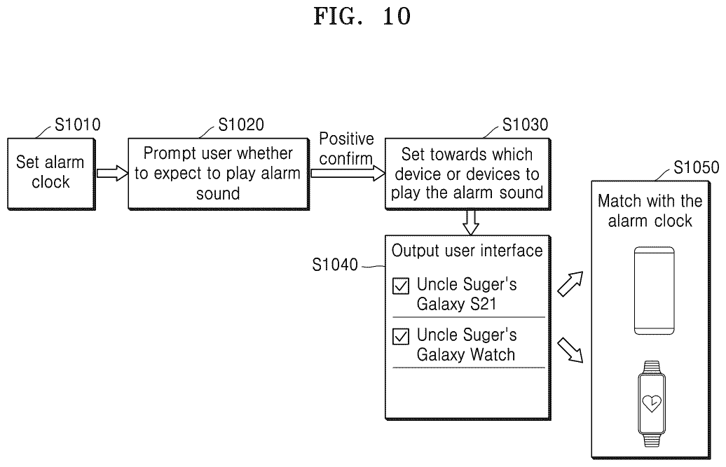

Hereinafter, an operation method of the second electronic apparatus according to the embodiment of the present disclosure will be described with reference to FIGS. 9 and 10.

FIG. 9 is a flowchart of an operation method of the second electronic apparatus according to an exemplary embodiment of the present disclosure.

Referring to FIG. 9, at operation S910, alarm clock setting information of at least one alarm clock is generated. As mentioned above, the alarm clock setting information may include, but not limited to, alarm time information, alarm sound information of each of the at least one alarm clock, and related information of a third electronic apparatus matched with each alarm clock. The above description about the alarm clock setting information is applicable to the embodiment described in FIG. 9 and will not be repeated here. As described above, the third electronic apparatus is an electronic apparatus toward which the alarm sound is played. In addition, the third electronic apparatus and the second electronic apparatus may be the same or different.

As an example, the generating of the alarm clock setting information of the at least one alarm clock may include: outputting prompt information, wherein the prompt information prompts the user whether to expect to play the alarm sound using the first electronic apparatus; if a confirmation input about playing the alarm sound using the first electronic apparatus is received, outputting a user interface for setting a third electronic apparatus matched with each alarm clock; in response to an input on the user interface, generating related information of the third electronic apparatus matched with each alarm clock as one of the alarm clock setting information.

FIG. 10 is a schematic diagram illustrating setting the third electronic apparatus matched with the alarm clock. According to an exemplary embodiment, when the user sets the alarm clock (operation S1010) on the second electronic apparatus (such as the user's mobile phone), the second electronic apparatus may prompt the user whether to expect to play the alarm sound (operation S1020) using the first electronic apparatus (such as the smart alarm clock), by outputting prompt information. Or, after the second electronic apparatus is connected to the local area network in a space where a plurality of users are located commonly, the second electronic apparatus may prompt the user whether to expect to play the alarm sound using the first electronic apparatus, by outputting prompt information. For example, as illustrated in FIG. 10, the above prompt information may be “whether to synchronize to the smart alarm clock?”. If the user's positive confirmation is received, the user may be further prompted to set towards which device or devices to play the alarm sound. (operation S1030) According to the embodiment, if the user of the second electronic apparatus confirms to play the alarm sound using the first electronic apparatus, the second electronic apparatus may output the user interface for setting the third electronic apparatus matched with each alarm clock, after receiving a confirmation input about playing the alarm sound using the first electronic apparatus. (operation S1040) By the input on the user interface, the user may set the related information of the third electronic apparatus, which may be one of the alarm clock setting information described above. For example, the user may check the third electronic apparatus that is expected to be matched with the alarm clock on the user interface where a plurality of candidate third electronic apparatus are displayed. (operation S1050) For example, as illustrated in FIG. 10, the user may select two electronic apparatus named “Uncle Suger's S21” and “Uncle suger's Galaxy Watch” as the third electronic apparatus matched with the set alarm clock, and in the future, the alarm sound will be played towards these two electronic apparatus. The second electronic apparatus may generate the related information of the third electronic apparatus matched with each alarm clock as one of the alarm clock setting information, in response to the input on the user interface. The above mode of generating the related information of the third electronic apparatus is only an example, and the related information of the third electronic apparatus may be generated in other modes (for example, inputting the related information of the third electronic apparatus directly on the alarm clock setting interface, without prompting). The related information may include information such as the name and MAC address of the third electronic apparatus. In addition, as described above, the alarm clock setting information may include the alarm time information and the alarm sound information in addition to the related information of the third electronic apparatus. The alarm time information and the alarm sound information may be set by using any alarm clock setting mode, and the present disclosure is not limited thereto.

Referring back to FIG. 9, after generating the alarm clock setting information, next, at operation S920, the alarm clock setting information is sent to the first electronic apparatus. The alarm clock setting information may be used by the first electronic apparatus to determine the alarm sound playing direction corresponding to each of the at least one alarm clock, to play the alarm sound corresponding to each alarm clock toward the alarm sound playing direction. As an example, the second electronic apparatus may send the alarm clock setting information to the first electronic apparatus directly, or send the alarm clock setting information to the first electronic apparatus via the intermediate communication apparatus or the cloud. For example, the second electronic apparatus may first send the alarm clock setting information to the intermediate communication apparatus, and then the intermediate communication apparatus may send the alarm clock setting information to the first electronic apparatus; or, the second electronic apparatus may first send the alarm clock setting information to the cloud, and then the first electronic apparatus may obtain the alarm clock setting information by accessing the cloud.

According to an embodiment, the third electronic apparatus and the second electronic apparatus may be the same or different. The third electronic apparatus being the same as the second electronic apparatus, indicates that the electronic apparatus that sets the alarm clock is the electronic apparatus toward which the alarm sound will be played in the future. The third electronic apparatus being different from the second electronic apparatus, indicates that the electronic apparatus that sets the alarm clock is not the electronic apparatus toward which the alarm sound will be played in the future, that is, the second electronic apparatus may set the alarm sound to be played in the future toward other electronic apparatus.

Alternatively, in the case that the third electronic apparatus and the second electronic apparatus are the same electronic apparatus, and the first electronic apparatus and the third electronic apparatus include an ultra-wideband (UWB) module, the operation method of the second electronic apparatus illustrated in FIG. 9 may further include: establishing a communication connection with the first electronic apparatus, and exchange ultra-wideband (UWB) ranging parameters with the first electronic apparatus, wherein the ultra-wideband (UWB) ranging parameters are used to determine the alarm sound playing direction. In the above description of the operation method of the first electronic apparatus, the exchange of the ultra-wideband (UWB) ranging parameters and how to determine the alarm sound playing direction based on the UWB ranging parameters have been described, thus it will not be repeated here.

According to the operation method of the second electronic apparatus, by generating and sending the alarm clock setting information to the first electronic apparatus, the alarm sound playing direction corresponding to the alarm clock may be determined by the first electronic apparatus based on the alarm clock setting information, and then the alarm sound corresponding to the alarm clock is played toward the alarm sound playing direction, thereby reducing the impact of the alarm sound on others.

The operation methods of the first electronic apparatus and the second electronic apparatus according to the embodiments of the present disclosure have been described above, and the composition of the first electronic apparatus and the second electronic apparatus according to the embodiments will be briefly described below.

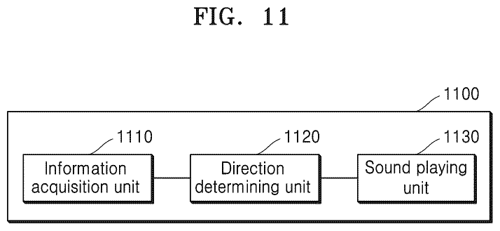

FIG. 11 is a block diagram of the first electronic apparatus according to an exemplary embodiment of the present disclosure. As illustrated in FIG. 11, the first electronic apparatus 1100 may include an information acquisition unit 1110, a direction determining unit 1120, and a sound playing unit 1130. Specifically, the information acquisition unit 1110 may be configured to acquire alarm clock setting information of at least one alarm clock from at least one second electronic apparatus. The direction determining unit 1120 may be configured to determine an alarm sound playing direction corresponding to each of the at least one alarm clock respectively, based on the alarm clock setting information. The sound playing unit 1130 may be configured to play an alarm sound corresponding to each alarm clock toward the alarm sound playing direction.

As an example, the information acquisition unit 1110 may include a network connection module that may receive the alarm clock setting information in the local area network. The direction determining unit 1120 may include a UWB module and a calculating module, the UWB module may be used to locate a third electronic apparatus (the third electronic apparatus may also include a UWB module), and the calculating module may calculate the alarm sound playing direction based on the determined position of the third electronic apparatus. For example, one first electronic apparatus (e.g., smart alarm clock) may be placed in the same bedroom, and the alarm clocks set by the roommates may be synchronized to the smart alarm clock through BT or Data network through WI-FI. The ringing of different alarm clocks only propagates sound to the direction of the alarm clock setter's apparatus, so as to achieve the effect of directional playing and not interfere with other people's sleep.

Any relevant details involved in the operations performed by the above-mentioned units may be referred to the corresponding descriptions of FIGS. 2 to 8, and will not be repeated here. In addition, it should be noted that, although the first electronic apparatus 1100, as being described above, is divided into units for performing respective processing respectively, it is clear to those skilled in the art that the processing performed by the above units may also be performed in the case that any specific unit division is not performed on the first electronic device 1100 or there is no clear demarcation between the units. In addition, the first electronic apparatus 1100 may also include other units, such as a storage unit, etc. For example, the storage unit may store the acquired alarm clock setting information.

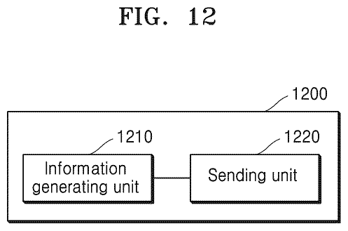

FIG. 12 is a block diagram of the second electronic apparatus according to an exemplary embodiment of the present disclosure. Referring to FIG. 12, the second electronic apparatus may include an information generating unit 1210 and a sending unit 1220. The information generating unit 1210 may be configured to generate alarm clock setting information of at least one alarm clock. The sending unit 1220 may be configured to send the alarm clock setting information to the first electronic apparatus, and the alarm clock setting information is used by the first electronic apparatus to determine an alarm sound playing direction corresponding to each of the at least one alarm clock, to play an alarm sound corresponding to each alarm clock toward the alarm sound playing direction. According to an exemplary embodiment, the third electronic apparatus and the second electronic apparatus may be the same electronic apparatus, and the first electronic apparatus and the third electronic apparatus may include an ultra-wideband (UWB) module. The UWB module included in the second electronic apparatus may be configured to establish a communication connection with the first electronic apparatus, and exchange ultra-wideband (UWB) ranging parameters with the first electronic apparatus, wherein the ultra-wideband (UWB) ranging parameters are used to determine the alarm sound playing direction.

Any relevant details involved in the operations performed by the above-mentioned units may be referred to the corresponding descriptions of FIGS. 9 to 10, and will not be repeated here. In addition, it should be noted that, although the second electronic apparatus 1200, as being described above, is divided into units for performing respective processing respectively, it is clear to those skilled in the art that the processing performed by the above units may also be performed in the case that any specific unit division is not performed on the first electronic device 1100 or there is no clear demarcation between the units. In addition, the second electronic apparatus 1200 may also include other units, such as a storage unit, etc. For example, the storage unit may store the generated alarm clock setting information.

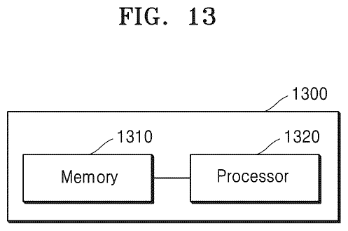

FIG. 13 is a block diagram of an electronic apparatus according to an exemplary embodiment of the present disclosure.

Referring to FIG. 13, the electronic apparatus 1300 may include at least one memory 1310 storing computer executable instructions and at least one processor 1320, the computer executable instructions, when executed by the at least one processor 1320, cause the at least one processor 1320 to perform the operation method according to the embodiment of the present disclosure.

As an example, the electronic apparatus may be a PC computer, a tablet device, a personal digital assistant, a smart phone, or other device capable of executing the above instruction set. Here, the electronic apparatus does not have to be a single electronic apparatus, but may also be a collection of any device or circuit capable of executing the above instructions (or instruction set) individually or jointly. The electronic apparatus may also be a part of an integrated control system or system manager, or may be configured as a portable electronic apparatus interfaced with the local or remote (e.g., via wireless transmission).

In the electronic apparatus, the processor may include a central processing unit (CPU), a graphics processor (GPU), a programmable logic device, a dedicated processor system, a microcontroller, or a microprocessor. As an example, rather than limitation, the processor may also include an analog processor, a digital processor, a microprocessor, a multi-core processor, a processor array, a network processor, etc.

The processor may execute instructions or code stored in the memory, wherein the memory may also store data. The instructions and data may also be sent and received over the network via a network interface device, which may use any known transmission protocol.

The memory may be integrated with the processor, for example, a RAM or a flash memory may be arranged within an integrated circuit microprocessor or the like. In addition, the memory may include a separate device, such as an external disk drive, a storage array, or other storage device that may be used by any database system. The memory and the processor may be operatively coupled, or may communicate with each other, for example, through I/O ports, network connections, etc., so that the processor can read files stored in the memory.

In addition, the electronic apparatus may also include a video display (such as a liquid crystal display) and a user interaction interface (such as a keyboard, a mouse, a touch input device, etc.). All components of the electronic apparatus may be connected to each other via a bus and/or a network.

According to an embodiment of the present disclosure, there may also be provided a computer-readable storage medium storing instructions, wherein the instructions, when executed by at least one processor, cause the at least one processor to execute the operation method according to the exemplary embodiment of the present disclosure. Examples of computer readable storage media herein include read only memory (ROM), random access programmable read only memory (PROM), electrically erasable programmable read only memory (EEPROM), random access memory (RAM), dynamic random access memory (DRAM), static random access memory (SRAM), flash memory, nonvolatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu ray or optical disk memory, hard disk drive (HDD), solid state disk (SSD), card type memory (such as multimedia card, secure digital (SD) card or extreme speed digital (XD) card), magnetic tape, floppy disk, magneto-optical data storage device, optical data storage device, a hard disk, a solid-state disk, and any other device configured to store a computer program, and any associated data, data files and data structures, in a non-transitory manner, and provide the a computer program, and any associated data, data files and data structures to the processor or computer, so that the processor or computer can execute the computer program. The instructions or computer programs in the above-mentioned computer-readable storage medium may run in an environment deployed in a computer apparatus such as a client, a host, a proxy device, a server, etc., and in addition, in one example, the computer programs and any associated data, data files and data structures are distributed on a networked computer system, so that the computer programs and any associated data, data files and data structures are stored, accessed and executed in a distributed manner by one or more processors or computers.

Those skilled in the art may think of other embodiments of the present disclosure after considering the description and practicing the disclosed embodiments. The present application is intended to cover any variation, use or adaptive change of the present disclosure, which follows the general principles of the present disclosure and includes the common knowledge or customary technical means in the technical field, which is not disclosed by the present disclosure. The description and the embodiments are only considered as exemplary, and the true scope and spirit of the present disclosure are defined by claims.

What is claimed is:

1. A method of operating a first electronic apparatus, the method comprising:
acquiring alarm clock setting information of at least one alarm clock from at least one second electronic apparatus;
determining, based on the alarm clock setting information, an alarm sound playing direction corresponding to each alarm clock of the at least one alarm clock; and
for each alarm clock of the at least one alarm clock, playing an alarm sound corresponding to the alarm clock toward the alarm sound playing direction corresponding to the alarm clock.

2. The method of claim 1,
wherein the alarm clock setting information comprises alarm time information for each alarm clock of the at least one alarm clock, alarm sound information for each alarm clock of the at least one alarm clock, and related information of a third electronic apparatus matched with each alarm clock of the at least one alarm clock.

3. The method of claim 2, wherein the third electronic apparatus is the at least one second electronic apparatus.

4. The method of claim 2, wherein the determining the alarm sound playing direction corresponding to each alarm clock of the at least one alarm clock comprises:
determining a position of the third electronic apparatus based on the related information of the third electronic apparatus matched with each alarm clock of the at least one alarm clock; and
determining the alarm sound playing direction of each alarm clock of the at least one alarm clock according to the determined position of the third electronic apparatus.

5. The method of claim 4, wherein the determining the position of the third electronic apparatus based on the related information of the third electronic apparatus comprises determining the position of the third electronic apparatus using ultra wideband (UWB) positioning technology.

6. The method of claim 1, wherein the determining, based on the alarm clock setting information, the alarm sound playing direction corresponding to each alarm clock of the at least one alarm clock comprises:
determining an alarm sound playing time of each alarm clock of the at least one alarm clock according to the alarm clock setting information; and
determining, for each alarm clock of the at least one alarm clock, within a predetermined time before the alarm sound playing time, the alarm sound playing direction corresponding to the alarm clock.

7. The method of claim 6,
wherein the at least one alarm clock comprises a plurality of alarm clocks, and the first electronic apparatus comprises a plurality of sound players, and
wherein, for each alarm clock of the plurality of alarm clocks, the playing the alarm sound corresponding to the alarm clock toward the alarm sound playing direction corresponding to the alarm clock further comprises:
based on the alarm sound playing time of each alarm clock of the plurality of alarm clocks being the same, simultaneously playing, through the plurality of sound players, the alarm sound corresponding to each alarm clock toward the respective alarm sound playing direction corresponding to each of the plurality of alarm clocks.

8. The method of claim 6,
wherein the at least one alarm clock comprises a plurality of alarm clocks, and the first electronic apparatus comprises one sound player, and
wherein, for each alarm clock of the plurality of alarm clocks, the playing of the alarm sound corresponding to each alarm clock toward the respective alarm sound playing direction comprises:
based on the alarm sound playing time of each of the plurality of alarm clocks being the same, alternately playing in time intervals, through the one sound player, the alarm sound corresponding to each alarm clock in the respective alarm sound playing direction corresponding to each respective alarm clock of the plurality of alarm clocks.

9. The method of claim 1, wherein the acquiring the alarm clock setting information of the at least one alarm clock from the at least one second electronic apparatus comprises:
receiving the alarm clock setting information directly from the at least one second electronic apparatus; or
acquiring the alarm clock setting information via an intermediate communication apparatus or by accessing a cloud device.

10. A method of operating an alarm management system, the method comprising:
generating, by at least one second electronic apparatus, alarm clock setting information of at least one alarm clock;
sending, by the at least one second electronic apparatus, the alarm clock setting information to a first electronic apparatus;
determining, by the first electronic apparatus, an alarm sound playing direction corresponding to each alarm clock of the at least one alarm clock based on the alarm clock setting information; and
playing, by the first electronic apparatus for each alarm clock of the at least one alarm clock, an alarm sound corresponding to the alarm clock toward the alarm sound playing direction.

11. The method of claim 10, wherein the alarm clock setting information comprises alarm time information for each alarm clock of the at least one alarm clock, alarm sound information for each alarm clock of the at least one alarm clock, and related information of a third electronic apparatus matched with each alarm clock of the at least one alarm clock.

12. The method of claim 11,
wherein the third electronic apparatus is the at least one second electronic apparatus,
wherein the first electronic apparatus and the third electronic apparatus each comprise an ultra-wideband (UWB) module,
wherein the method further comprises:
establishing a communication connection between the first electronic apparatus and the at least one second electronic apparatus;
exchanging a UWB ranging parameter between the first electronic apparatus and the at least one second electronic apparatus, and
wherein the determining, by the first electronic apparatus, the alarm sound playing direction corresponding to each alarm clock of the at least one alarm clock further comprises determining the alarm sound playing direction corresponding to each alarm clock of the at least one alarm clock using the UWB ranging parameter.

13. The method of claim 10, wherein the generating the alarm clock setting information of the at least one alarm clock comprises:
outputting, by the at least one second electronic apparatus, prompt information to a user;
based on expectation information provided by the user in response to the prompt information, identify whether the user expects the alarm sound corresponding to each alarm clock of the at least one alarm clock to be output by the first electronic apparatus;
based on identifying that the user expects the alarm sound corresponding to each alarm clock of the at least one alarm clock to be output by the first electronic apparatus, outputting a user interface for setting a third electronic apparatus matched with each of the at least one alarm clock; and
based on an input received through the user interface, generating related information of the third electronic apparatus matched with each of the at least one alarm clock as at least part of the alarm clock setting information.

14. The method of claim 10, wherein the sending the alarm clock setting information to the first electronic apparatus comprises:
sending the alarm clock setting information directly to the first electronic apparatus; or
sending the alarm clock setting information to the first electronic apparatus via an intermediate communication apparatus or a cloud device.

15. A first electronic apparatus comprising:
at least one memory storing one or more instructions; and
at least one processor configured to execute the one or more instructions, wherein the one or more instructions, when executed by the at least one processor, cause the first electronic apparatus to:
acquire alarm clock setting information of at least one alarm clock from at least one second electronic apparatus,
determine, based on the alarm clock setting information, an alarm sound playing direction corresponding to each alarm clock of the at least one alarm clock, and
for each alarm clock of the at least one alarm clock, play an alarm sound corresponding to the alarm clock toward the alarm sound playing direction corresponding to the alarm clock.

16. The first electronic apparatus of claim 15, wherein the alarm clock setting information comprises alarm time information for each alarm clock of the at least one alarm clock, alarm sound information for each alarm clock of the at least one alarm clock, and related information of a third electronic apparatus matched with each alarm clock of the at least one alarm clock.

17. The first electronic apparatus of claim 16, wherein the one or more instructions, when executed by the at least one processor, cause the first electronic apparatus to:
determine a position of the third electronic apparatus based on the related information of the third electronic apparatus matched with each alarm clock of the at least one alarm clock, and
determine the alarm sound playing direction of each alarm clock of the at least one alarm clock according to the determined position of the third electronic apparatus.

18. The first electronic apparatus of claim 17, wherein the one or more instructions, when executed by the at least one processor, cause the first electronic apparatus to:
determine the position of the third electronic apparatus using ultra wideband positioning technology.

19. The first electronic apparatus of claim 15, wherein the one or more instructions, when executed by the at least one processor, cause the first electronic apparatus to:
determine an alarm sound playing time of each alarm clock of the at least one alarm clock according to the alarm clock setting information; and
determine, for each alarm clock of the at least one alarm clock, within a predetermined time before the alarm sound playing time, the alarm sound playing direction corresponding to the alarm clock.

20. A non-transitory computer readable medium having instructions stored therein, which when executed by at least one processor cause the at least one processor to execute a method of operating a first electronic apparatus, the method comprising:
acquiring alarm clock setting information of at least one alarm clock from at least one second electronic apparatus;
determining, based on the alarm clock setting information, an alarm sound playing direction corresponding to each alarm clock of the at least one alarm clock; and
for each alarm clock of the at least one alarm clock, playing an alarm sound corresponding to the alarm clock toward the alarm sound playing direction corresponding to the alarm clock.
